(19) United States
(12) Patent Application Publication
(10) Pub. No.: US 2013/0002415 A1
(43) Pub. Date: Jan. 3, 2013

(54) Vehicular telematics device with voltage sensor-predicated GPS reciever activation

(75) Inventors: Thomas Walli, Oakville (CA); Anthonios Partheniou, Oakville (CA); Clive Cawse, Oakville (CA); Darren Beams, Oakville (CA); Neil Cawse, Oakville (CA)

(73) Assignee: Geotab Inc., Oakville (CA)

(21) Appl. No.: 13/067,799

(22) Filed: Jun. 28, 2011

(51) Int. Cl. B60Q 1/00; G06F 7/00

(52) U.S. Cl. 340/438; 701/1; 701/36

(57) ABSTRACT

A vehicle-status-evaluating device is operable to distinguishably sense between inactive-vehicle and active-vehicle states and includes a power-switch operable to selectively power-up an associated vehicular device in response to a vehicle-status-evaluating device sensed active-vehicle state. An on-board, battery-powered telematics device, a telematics system, and a telematics display and a related method are included.

### FIELD OF THE INVENTION

The present invention relates to vehicular telematics devices and especially to vehicular navigational telematics devices and vehicle battery capacity conservation—navigation wake-up methods relating to same.

### BACKGROUND OF THE INVENTION

Vehicular battery power is a limited resource. For internal combustion driven vehicles, sufficient reserves are essential for reliable vehicle starts. For electrically powered vehicles, the battery charge is in effect the fuel whose availability constrains the vehicles operational range.

In all such vehicles, any electrically powered accessories depend upon the battery-stored charge unless some alternative power supply (e.g. an on-board charging system, a generator set, a connection to an electrical utility grid, etc.) is actively providing power to the vehicle.

In cases where large stored-capacity demands are to be served, (as in RV terrestrial or marine vehicles, for example), auxiliary “house” batteries are often employed to meet any anticipated amp-hour demands, without taxing dedicated “cranking” battery reserves. Typical “house” batteries are “deep cycle” wet cell (e.g. lead/acid cell) designs—and characteristically have thick, higher density plates that are well suited to a sustained, relatively slow release of the chemically-stored potential electrical energy, and less well suited to delivering the fast, high energy bursts required to power a starter motor of an internal combustion engine.

More typically, however, automotive vehicles' electrical storage needs are served by a single, all purpose battery—which in the case of an internal-combustion-engine-powered vehicle, must be designed primarily to facilitate the engine cranking function. Accordingly, such a “cranking” battery is characteristically possessed of thinner (weaker) and more porous electrode plate designs that are suited for providing the large electrolyte contact surface area required to facilitate more rapid conversion of the battery's chemical potential energy into useful electrical power.

Moreover, batteries “age” in the sense that they have a limited number of useful duty cycles—which is to say that their useful storage capacity declines with each and every discharge/recharging cycle that they are subjected to. In the case of wet cell lead acid batteries, for example, sulphation and erosion of active electrode surface materials deplete a battery's storage capacity. The depth of discharge is an acutely aggravating factor in this battery-aging phenomenon—and while deep cycle batteries are somewhat less affected by this problem, automotive cranking batteries are especially prone to its adverse effects. The effects are also not linear: as the depth of discharge increases, a battery's life expectancy is disproportionately shortened. By way of illustration, a given battery might cycle through 10% of its discharge capacity over a life time of 2000 duty cycles; but only for 500 duty cycles at 50% of its discharge capacity; and only 100 duty cycles if drawn down by 100% of its discharge capacity.

Ambient operating conditions further compound batter storage capacity problems—although in some climates this is not a very substantial issue. Note, however, that a battery having 100% capacity at 80 degrees Fahrenheit ambient temperatures, will have only 18% of that capacity at −20 degrees Fahrenheit—while the power required to start and engine at that lower temperature is 268% of that required at the higher ambient temperature.

Other factors such as self-discharge and rate of active discharge are also material in considering “scarcity” of battery storage capacity.

Lastly, while the operationally useful capacity of a vehicular battery is of critical importance on a day-to-day basis, there are also the environmental implications that attend foreshortened battery life overall. The recycling/disposal costs are not at all insignificant.

Accordingly, there is, in general, a substantial need to carefully manage the use of vehicular battery storage capacity. In the particular context of the present invention, the focus of such conservation is through the managed use of battery storage capacity in relation to awakening vehicular telematics devices, and especially navigational telematics devices, from a dormant state, either in anticipation of, or in reaction to a vehicle's transition from an inactive (i.e. shut-off) to an active condition.

It is not unusual for vehicular telematics devices in shut-off vehicles, to go dormant and only periodically reactivate to accomplish one or more of three functions: 1) monitor the inactive/active” status of that vehicle, 2) update any navigational data references (as in the case of a GPS updating ephemeris and/or almanac data) and 3) signal a telematics system integrity check/confirmation by logging/transmitting the vehicle's position and any collateral operational information.

Typically such arrangements involve the vehicular telematics device being powered up according to some pre-determined schedule, in response to some form of clock-driven signal. If nothing has changed, the device ascertains that the vehicle remains inactive and the device shuts down again, hibernating until the next scheduled periodic check. There is a cost to the vehicular battery capacity for each such transaction—and so the frequency of these monitoring events becomes a trade-off between battery capacity consumption, performing any navigational updates, verifying telematics system integrity and, capturing any change in the vehicle's operational status. The more often such a monitoring event takes place, the more reliable (or at least current) the status check is. On the other hand, in navigational telematics systems in particular, power is typically drawn at 0.5 to 1.5 amps—and the “time to first fix” needed to ascertain whether or not a vehicle is in motion, can be as long as 12 minutes before the system can ascertain the vehicle's continuing “inactive” status, and shut down pending the next scheduled check. The cumulative drain on a vehicle's battery when it is parked “over night” or over a weekend has a substantial adverse impact on battery capacity in all the ways contemplated above.

The latter two of the above mentioned functions associated with having the telematics device come out of hibernation periodically, can be reasonably facilitated with relatively few “wake ups”—and hence relatively little draw on the vehicle's battery capacity. Only the first function, (a change in the vehicle's status from inactive to active), requires a higher frequency of system “wake ups” if it is to meaningfully capture any such change (i.e. unauthorized use of the vehicle). Moreover and with the issue of power utilization aside, reliance on merely periodic checks is not an ideal way to capture such unauthorized change in status—because such a method it is not actually sensitive to the change in status, but only coincidentally captures it if and when a periodic wakeup catches the vehicle out of position. For example, if a wakeup occurs at the top of every hour, then a vehicle could be taken for an unauthorized drive and returned to its parked location at any time during the hour, and the system could be entirely blind to the event. Even if the vehicle is outright stolen, it is possible in such a circumstance that the vehicle could be gone for nearly a full hour before the system responded to the event. Even if the vehicle's operation is authorized, the slavish periodicity of a “clock-driven” device may miss the start of the work day, and not become telemetrically aware until the next scheduled periodic wakeup.

Accordingly, while there is both purposeful value in periodic wakeup cycling of a vehicular telematics device to verify that the telematics system as a whole is functioning as intended, there also remains an ongoing need for a vehicular telematics device that is autonomously sensitive to vehicle operational status changes, (i.e. from inactive to active operating states), without pedantically drawing down on the monitored vehicles battery storage capacity by slavishly performing periodic checks over some predetermined schedule that may in itself have nothing to do with any change in the vehicle's operational state, and at best only coincidentally detect such a change sooner rather than later.

### SUMMARY OF THE INVENTION

In accordance with one aspect of the present invention, there is provided a vehicle-status-evaluating means operable to distinguishably sense between inactive-vehicle and active-vehicle states. The vehicle-status-evaluating means includes a power-switching means that is operable to selectively power-up an associated vehicular device in response to a vehicle-status-evaluating device means active-vehicle state.

The present invention can facilitate purposeful correlation between the operations of the associated vehicular device and the operational status of the vehicle itself—particularly, although not necessarily exclusively, in order to achieve at least some level of parsimony in how vehicular battery reserves are consumed during inactive-vehicle states. This is especially advantageous in connection with associated vehicle devices serving functions which are contingent on power-up operations during inactive-vehicle states as distinguished from functions that are served only once the vehicle transitions from an inactive to an active state. Moreover, since the inactive vehicle state is often if not typically a state in which the vehicle is not closely attended by any authorized human agency, the autonomous nature of the cooperating means not only can keep the associated vehicle device “primed” (see for example, in the sense of the GNSS navigation application described elsewhere herein), but circumstantially responsive in the sense of a telemetrically monitored security application, (also as a elaborated elsewhere herein).

Preferably the power-switching means is operable to selectively power-up and power-down an associated vehicular device in response, respectively, to corresponding, vehicle-status-evaluating means sensed active-vehicle and inactive-vehicle states. In vehicular operations management applications, for example, it is desirable to ensure that associated vehicle devices are timely and reliably activated when the vehicle transitions from an inactive to an active state—to forefend against a vehicle operator's forgetfulness or even deliberate malfeasance. By providing for an autonomous power up of the device, the risk of an operator's interference may be avoided.

In a particularly preferred form of the present invention, the power-switching means also includes clock means operable to periodically power-up the associated vehicular device. The cooperation of the vehicle-status evaluating means and the power-switching device—together with the clock means, in embodiments that includes same—variously facilitates battery conservation strategies for selectively powering the associated vehicular device during inactive-vehicle states. In the case of an associated vehicular device such as a GNSS navigation in-vehicle receiver, for example, the clock means can be set to power-up the receiver at times during inactive vehicle states, corresponding to the navigation system's control segment broadcasts of updated ephemeris and/or almanac information. Typically, a two or three hour power-up/down cycle might be employed in this connection to aid in keeping “time to first fix” delays reasonably brief when the vehicle enters an active-vehicle state. In responding to a security challenge, (vehicle theft or some other unauthorized appropriation of the asset), or even in keeping track of the early portion of an authorized use (as in the case of the first part of a “working day” use of a delivery truck), is thus timely and reliably facilitated with reasonable expectations of accurate vehicular tracking.

### INTRODUCTION TO THE DRAWINGS

FIG. 1 of the drawings appended hereto is a block diagram schematically depicting the connection and functional relationships between various features of a preferred embodiment of the present invention.

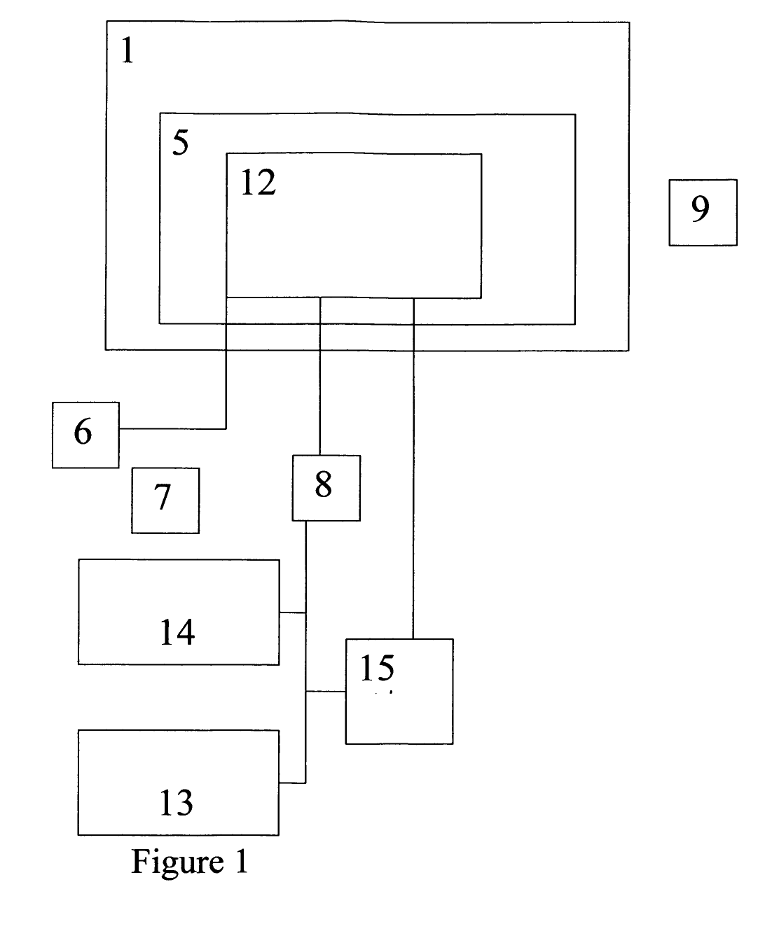

### DETAILED DESCRIPTION OF THE INVENTION

According to the present invention, a vehicle-status-evaluating means operable to distinguishably sense between inactive-vehicle and active-vehicle states. Inactive and active vehicles states are, for example, distinguishable by their electrical activity, and/or their movement.

Electrically speaking, a vehicle is inactive when its engine is not engaged—either in the operating or starting sense. From this perspective, electrical noise overlaying the vehicles supply of power is indicative of an operating engine, (with the noise or ripple being a good indicator of vehicle charging system activity), while a voltage drop in that supply, is generally useful in predicting an engine start—(especially if the voltage drop is characteristic in degree and duration of the voltage drop caused by solenoid engagement/starter motor activation). Another exemplary electrical cue that signals the transition from an inactive to an active vehicle state can be derived from the voltage change that takes place when a vehicle control module communications bus changes from a low voltage quiescent state, to the high (relatively speaking) voltage active state that attends actual or incipient use of the vehicle. Note, however, that these three exemplary “triggers” can provide differing insights into the vehicle's status: the communication bus changes state when the ignition circuit goes active, but does not depend on the engine actually being started, or actually running; while the voltage drop can, as indicated above, signal an attempt to start the vehicle, whether or not the engine actually starts; and, the electrical noise actually signifies that the engine is running (with the charging system noise serving as a proxy in that connection). While any of these triggers can usefully serve the relatively simple purpose of powering up the associated vehicle device, the differences between them can hold significance for the intended application of the present invention. For example, merely energizing the ignition circuit, (which as mentioned above collaterally transitions the communications bus from low to high voltage) without engaging the starting system may signify a routine maintenance check of a vehicle in an inactive state—and in a telematics security application of the present invention, the activation of the vehicle associated telematics device based on such a trigger, may usefully so distinguish from a vehicle start-up attempt. Likewise, a voltage drop that signifies an attempt to start a vehicles engine does not necessarily confirm an engine startup. If the attempt is unauthorized, then an appropriate security response to a telemetrically signaled but unsuccessful engine startup (i.e. one in which no subsequent voltage noise trigger results) might follow a different protocol than a more urgent response to an actual engine start. In any event, the sooner the power up of a vehicle associated GNSS or other navigation device begins in response to one or the other of the above triggers, the better—in order to take maximum lead time advantage in order to offset “time to first fix” delays.

Similarly, acceleration (movement) triggers provide yet another perspective on the change of vehicular state from inactive to active. A vehicle that moves on its suspension but does not travel over ground might do so in response to a strong wind. In such a case, the additional verification of one of the other cues might be useful to avoid a “false” wind-precipitated power up of the associated vehicle device. A vehicle that is in motion, without any of the other trigger cues providing verification of a change of vehicle state, could signal the vehicle being towed or loaded/carried on a trailer, or its roll down an incline in the event of a braking failure. Alternatively, even an engine start may not be entirely relevant in some embodiments/applications of the present invention, unless the vehicle actually begins to move, (for example, an engine start might trigger a GPS power up to bring its navigational data up to a state of readiness, but a telematics log or transmitter power up or call initiation might only be appropriate if the vehicle actually relocates). In another sense, a collision impacting on an inactive vehicle might only be sensed by an accelerometer—and the vehicle in this context is active in the sense that it has been involved in a collision that, depending on the embodiment/application of the present invention, facilitates the collision-justified powering up the associated vehicle device (and whether in whole or in part) to variously affirm the location of the vehicle at the time of impact, log the event and/or communicate an incident report.

In light of the present disclosure, actual sensors (and their operational arrangement in relation to the vehicle), suitable to the purposes hereof, will be readily apparent to persons skilled in the related arts. Similarly, suitable power-switching means, (operable as stated to selectively power-up an associated vehicular device in response to a vehicle-status-evaluating means sensed active-vehicle state), will also be apparent to persons of ordinary skill without undue effort. Preferably, the power-switching means is operable to selectively power-up and power-down an associated vehicular device in response, respectively, to corresponding, vehicle-status-evaluating means sensed active-vehicle and inactive-vehicle states. For example, the power-switching means may respond to any one or more of the variously sensed vehicle active states, to maintain the associated vehicle device in a powered up state, and only power down that device when one or more of the triggers transitions into a state corresponding to an inactive vehicle state. By way of example, a voltage drop occasioned by engaging the solenoid/starter motor circuit could trigger an active vehicle state response, and a subsequent voltage drop as the vehicle engine shuts down (and the regulated alternator power supply to the battery is discontinued) could trigger an inactive vehicle response (i.e. a powering down of the associated vehicle device). This arrangement can aid in battery reserve conservancy—by keeping the associated vehicle device operational only for so long as the triggering event persists. On the other hand, if the triggering condition is transient, (which is to say, it provides a triggering impetus for too short a period of time to serve the purpose of powering up the associated vehicle device in the first place, then having the power switching means power down the associated vehicle device coterminously with the cessation of the sensed triggering event, may be premature. Accordingly, in other embodiments of the present invention, provision is made for clock means operable to variously provide for a power-down delay as well as other functions. For example, power-switching means can include clock means operable to periodically power-up the associated vehicle device independently of the divers other sensed triggering events.

Periodic, clock means triggered, powering of the associated vehicle device, (independently of any other sensed triggers), can be useful: in maintaining the operational readiness of the associated vehicle device itself (for which associated vehicle GNSS receivers requiring ephemeris or almanac data updates, are a good example); and/or in supporting periodic system integrity checks, (as can be useful in monitoring system integrity in a telematics monitoring system. In such cases, the clock means power-up can be either specific time or specific interval driven. In either case the clock means performs its function at a frequency suited to its intended purpose, which can be much less frequent than might be needed if the frequency was intended to provide for security against unauthorized use of the vehicle.

On the other hand, if the interval between successive clock means initiated power ups is important, but the actual time at which they occur is not, then there may be some additional battery power management advantages to setting the clock means interval to run for a predetermined period from the last power-down event, regardless of whether that event followed from a power-up event which was clock means or otherwise triggered, (i.e. the clock means triggering of a succeeding power-up is not strictly independent from a preceding power-up triggered in response to some other sensed condition). Such a dependency avoids potential redundancy in serial power ups—since an inactive to active vehicle change of state trigger power up will collaterally deliver an interim operational readiness update and/or system integrity check that might then not be revisited again until a full predetermined clock interval has lapsed from the power-down following from an otherwise triggered power-up. Accordingly, embodiments of the vehicle-status-evaluating means in the manner of the present invention can include clock means variously operable to: power-up the associated vehicular device at a predetermined time; and/or, power-up said associated vehicular device at a predetermined interval of time following from said associated vehicular devices latest power-down.

In addition the present invention contemplates further embodiments: including those in which the clock means is operable to power-down the associated vehicular device, either following the lapse of a predetermined time interval after the prevailing clock power-up of the device, or on some condition signaled by the device to indicate completion of a clock-mandated power-up task to be handled by the associated vehicle device. Either approach can facilitate vehicle battery reserves conservation. In the case of the former approach, for example, it is reasonable to assume that in most circumstances, a GPS receiver may successfully update its ephemeris codes within several minutes of startup, as so the associated vehicle GPS device can be powered down after that period of time since the continued draw of battery power beyond that period is not likely to improve the readiness state of the receiver until further control segment updates are available in about 2 to 3 hours. In the case of the latter approach, the GPS can elicit some form of a “satellite acquisition confirmation” signal to confirm that it has down loaded the required almanac and/or ephemeris data—to which the clock means can respond by powering down the receiver. Although this latter case does not involve a “timing” function in the strict clock sense, it is nevertheless (in the context of the present invention), a function notionally attributed to the “clock means” in that it controls how long the associated vehicle device draws on battery reserves before powering down.

In accordance with a particularly preferred vehicle-status-evaluating means of the present invention, one or more of sensing means are provided from the group consisting of:
Vehicle-power-supply-voltage-drop sensing means;
Vehicle-power-supply-voltage-noise sensing means;
Vehicle-control-system-communications-bus-high/low-voltage-change sensing means; and/or,
Vehicle-acceleration sensing means.

This vehicle status evaluating means distinguishes between inactive-vehicle and active-vehicle states corresponding to one or more of:
a vehicle-power-supply-voltage-drop sensing means sensed vehicle power supply voltage drop;
a vehicle-power-supply-voltage-noise sensing means sensed vehicle power supply voltage noise;
a vehicle-control-system-communications-bus-high/low-voltage-change sensing means sensed high/low voltage change on said vehicle control module communication bus; and/or,
a vehicle-acceleration-sensing means sensed vehicle acceleration.

The vehicle-acceleration sensing means comprises one or more of: shock-sensing means; and, vehicle travel-sensing (i.e. vehicle relocation) means. Functionally, these variants of the vehicle-acceleration sensing means distinguish collisions involving the parked vehicle, from actual vehicular travel.

In another embodiment of the present invention, the vehicle-status-evaluating means further includes signaling means to signal one or more of the: sensed vehicle power supply voltage drop; sensed vehicle power supply voltage noise; sensed high/low voltage change on said vehicle control module communication bus; and/or, sensed vehicle acceleration. These signals can then be usefully employed to report/interpret the circumstances that have given rise to the power-up of the vehicle associated device.

In a particularly preferred application, the present invention embodies a combination in which a GNSS receiver is operable in connection with a vehicle-status-evaluating means which in turn is itself operable (as variously described elsewhere herein) to distinguishably sense between inactive-vehicle and active-vehicle states and including power-switching means operable to selectively power-up the GNSS receiver in response to a vehicle-status-evaluating means sensed active-vehicle state. An especially preferred embodiment in this connection includes clock means for periodically powering up this receiver to download navigational data updates (e.g. ephemeris and/or almanac data), to aid in maintaining navigational readiness of the device in anticipation of the vehicle entering into an active state. GNSS stands for Global Navigation Satellite System and is used herein as a generic reference, to include for example: the US Naystar-GPS (which was later shortened simply to GPS, for global positioning system), as well as other regional/national satellite navigation systems in use or various stages of development include: Galileo, (a global system being developed and constructed by the European Union and other partner countries, and planned to be operational by 2013); Beidou, (People's Republic of China's experimental regional system) and COMPASS (a proposed global satellite positioning system by the People's Republic of China); GLONASS (Russia's global system which is being completed in partnership with India); IRNSS (India's regional navigation system covering Asia and the Indian Ocean only, and distinct from India's participation in GLONASS); and, QZSS (Japanese proposed regional system covering Japan only).

In such systems (taking GPS as a specific example) the control segment uploads a navigation message to respective satellites in the space segment constellation as a continuous 50 bits/second data stream modulated onto the carrier signal that is in turn broadcast by each of the satellites. The satellite message transmits data packaged in logical units called frames—and in the case of GPS a frame is 1500 bits long, so takes 30 seconds to be transmitted. Every satellite in the GPS constellation begins to transmit a frame precisely on the minute and half minute, according to its own clock, and each frame is divided into five subframes, each 300 bits long. The message content is divided into two parts, an ephemeris and an almanac. The highly accurate ephemeris and clock offset portion of the signal content is packaged in subframes 1, 2 and 3, and their “data content” is the same for a given satellite for consecutive frames for periods lasting as long as two hours—and with new subframe 1, 2 and 3 data sets usually being transmitted precisely on the hour (although sometimes earlier to facilitate what is referred to as cutovers for new uploads.

“Almanac” constellation portion of the signal content—comprises Subframes 4 and 5. These are said to be “subcommutated, meaning that consecutive subframes have different “data content”. This data does repeat, but 25 consecutive frames of subframe 4 and 5 data must be collected before the receiver has all of the unique almanac “data content” being transmitted by the satellite. The almanac is descriptive of all of the satellites in the constellation as a whole—as distinguished from the satellite-specific ephemeris data.

Satellite uploads typically occur about once every 24 hours for each satellite. A terrestrial master control station (MCS) sends the satellite all of the “data content” the satellite will transmit during the next 24 hours, plus data for the next few weeks in case a one or more subsequent uploads are delayed for some reason. Each upload contains roughly 16 ephemeris data sets. The satellite transmits a given set based on its time of applicability—and when a satellite begins transmitting a new data set to replace the more aged set previously transmitted, it is referred to as a cutover. The first cutover after an upload may occur at any time of the hour, but subsequent cutovers of new ephemeris data sets from that upload only occur precisely on the hour. Each ephemeris data set is transmitted for no more than two hours, (with some being transmitted for exactly an hour, others for exactly two hours and for those transmitted by the satellite either immediately before or after an upload, for a period of less than two hours. The ephemeris data sets include satellite clock offset time-of-applicability and ephemeris time-of-applicability information. These two time-of-applicability values are almost always the same, and for a cutover that begins on an hour epoch, the time-of-applicability values are almost exactly two hours later than the initial transmission time of the ephemeris data set.

A typical GPS receiver demodulates the navigation message data it receives from the satellite—looking continuously for any new ephemeris data sets. If the receiver detects a new ephemeris data set from a given satellite, it will begin to use that set in its navigational calculations. The receiver may also do something similar for the almanac, but it is less critical to have the latest almanac data so it may not collect every unique set, and usually an almanac is only collected from one of the satellites. An ephemeris data set is typically constituted to describe the clock and orbit of a given satellite for a four hour period, with the time-of-applicability near the center of that period. Note that since a data set is not transmitted for more than two hours, the time-of-applicability is almost always in the future, assuming the satellite is being tracked continuously. If a receiver is turned off and then back on some time later, the receiver could use either its saved almanac or latest ephemeris data set previously stored by the receiver, for re-acquiring the satellite broadcast signal. In terms of accuracy, the receiver could use the previously acquired ephemeris data set if the current time is not more than two hours past the time-of-applicability—since it can reasonably begin navigating as soon as it can establish so-called “pseudo-range” measurements, and thus not wait for a new data set to be actually received. In practice it can actually be more accurate to use ephemeris data sets that are even several more hours past the time-of-applicability, than resorting to the almanac data.

In accordance with the present invention, therefore, it is preferred that the clock means power-up the GNSS (e.g. GPS) to refresh its ephemeris, approximately every two hours—and to power-down the receiver if the vehicle still remains in an inactive state, once the receiver has had sufficient time to refresh at least a minimum of its ephemeris data, (or usefully acquired at least four satellite signals).

Referring now to the appended drawings, there is illustrated another embodiment of the present invention, comprising a telematics device 1 that is adapted to be used in vehicular battery powered, on-board applications.

Device 1 is comprised of vehicular operational sensing and/or positional sensing means 2 operable to be powered-down during corresponding states of vehicle inactivity. Means 2 is connected in data transferring relation to one or both of: operational and/or positional data reporting telecommunications means 3; and, operational and/or positional data logging means 4.

Device 1 includes vehicle status evaluating means 5 operable to distinguish between inactive vehicle and active vehicle states. Means 5 comprises one or more of the group consisting of:
vehicle power supply voltage drop sensing means 6;
vehicle power supply voltage noise sensing means 7;
vehicle control system communications bus high/low voltage change sensing means 8;
vehicle acceleration sensing means 9 comprising one or more of: shock-sensing means; and, vehicle relocation-sensing means.

In operation, vehicle status evaluating means 5 distinguishes between inactive and active vehicle states corresponding to one or more of:
a vehicle power supply voltage drop sensing means sensed vehicle power supply voltage drop;
a vehicle power supply voltage noise sensing means sensed vehicle power supply voltage noise;
a vehicle control system communications bus high/low voltage change sensing means sensed high/low voltage change on said vehicle control module communication bus; and/or,
a sensed vehicle acceleration.

Vehicle status evaluating means 5 is co-operable with said vehicular operational sensing and/or positional sensing means 2 to selectively power-up the vehicular operational and/or positional sensing means 2 in response to a vehicle status evaluating means 5 sensed active state.

The vehicular operational and/or positional sensing means 2 is in turn:
operable to sense corresponding operational and/or positional conditions verifying sensing-means sensed inactive or active states of a vehicle equipped with said device; and,
operable to respectively report/log a verified vehicle state.

Device 1 further comprises clock means 10 which is operable to periodically power-up the powered-down vehicular operational sensing and/or positional sensing means 5 during corresponding states of vehicle inactivity. More particularly, clock means 10 is operable to periodically power-up vehicular operational sensing and/or positional sensing means 5 during corresponding states of vehicle inactivity, at a predetermined period of time following powering-down thereof. Preferably, the operational sensing and/or positional sensing means 5 comprises a GNSS (e.g. GPS) receiver 11, and the predetermined period of time is selected to update said receiver's ephemeris data. Receiver 11 is operable to sense corresponding operational and/or positional conditions verifying various sensing-means (6, 7, 8 and/or 9) sensed inactivity or activity states of a vehicle equipped with device 1, by confirming changes in vehicular position data. For example, if voltage noise is detected in the manner described elsewhere herein, then a change in vehicle position sensed by receiver 11 verifies not only the sensed voltage noise condition, but also the operation of the vehicle.

In addition, it is preferred that the operational and/or positional data reporting telecommunications means 3 comprises wireless communications means. Exemplary wireless communications means in the context of the present invention include cellular wireless, Bluetooth, the IEEE 802.11 family of wireless standards (esp. 802.11 p WAVE), and the like. Cellular systems in particular are especially well suited for use in this connection.

Analog cellular telephone systems divide their bandwidth between “voice” and “control channels”. Each control channel set consists of a Forward Control Channel (FOCC) and a Reverse Control Channel (RECC). The FOCC is used to send general information from the cellular base station to the cellular telephone. The RECC is used to send information from the cellular telephone to the base station. The control channels are used to initiate a cellular telephone voice call. Once a telephone voice phone call is initiated, the cellular system directs that cellular telephone to a voice channel. After the cellular telephone has established service on a voice channel it never goes back to a control channel for the duration of that call—with all subsequent information concerning the hand-off to other voice channels and termination of the telephone call being handled via the voice channels. This leaves the control channels free to provide other services, such as telemetry, which is achieved by connecting a gateway to a port at the local mobile switching center (MSC) or regional facility. The gateway can process the telemetry messages according to the specific needs of the application—and can provide either batch processing or real-time continuous processing of the telemetry transaction.

One of the earliest services for sending data over a cellular communications network was “cellular digital packet data” (CDPD), which provided a way of passing internet protocol (IP) data packets used to transport data consists of the idle radio channels typically used for Advanced Mobile Phone System (AMPS) analog cellular systems. The packets were passed over analog cellular voice networks at speeds typically up to about 19.2 kbps. Although CDPD employs digital modulation and signal processing technology, the underlying services were still analog—(although notably, the idle channel utilization by a CPDP transmission does not suffer from the 3 kHz limit placed on voice transmissions and instead uses the entire 30 kHz RF bandwidth of the idle channel—which enables the above mentioned transmission speeds). Autonomous channel hopping techniques were used to search out idle channel times between cellular voice calls. Packets of data were sent out in short bursts on these idle channels—although some cellular carriers actually dedicated voice channels to meet high CPDP traffic demands of their subscribers. In operation, user data is packaged in accordance with IP protocols, and the packets are broken up and transmitted circuit-switched modems in the cell phone, to digital radios and routers located at the various cell sites. CPDP has been widely used for internet information browsing, but also for remote alarm monitoring applications.

Digital cellular phone (in particular, the Personal Communications Service of “PCS) systems have largely replaced analog cell phone systems. These digital systems offer a variety of services, and typically combine voice, data and control functions of a call on a single channel—and in many cases, simultaneously so. CDMA (code division multiple access) and TDMA (time division multiple access—which is used in GSM (Global System for Mobile Communications) phones) are signal multiplexing methodologies that facilitate multiple, overlapping uses of a single channel.

The evolution of digital cell phones has progressed into so-called 3G networks that are driven by packet technologies. The GPRS (General Packet Radio Service) is one such technology. One of the basic differences between 3G and earlier digital cell phones is that the cellular connection is always live (when the phone is turned on), so that a user does not have to initiate a phone call to make an internet connection.

Additional advances have been made: EDGE (Enhanced Data for Global Evolution), UMTS (Universal Mobile Telecommunications System) core networks, iMode and other transitional technologies, in anticipation of fourth generation cellular technology.

In general, modern wireless IP switches enable mobile operators to provide increasingly sophisticated data services in association with mobile environments. These switches are also seamlessly transport user traffic from the mobile data network onto the public data networks such as the internet. In this role wireless IP switches perform the function of the Packet Data Serving Node/Home, PDSN/HA) that supports CDMA 2000 wireless networks; and, a Gateway GPRS Support Node (GGSN), which supports GPRS and UMTS.

In a preferred device 1, vehicular operational and/or positional sensing means 5 comprises vehicular operational sensing means 12. Vehicular operational sensing means 12 comprises means for receiving or receiving/processing, whether directly or indirectly, vehicular sensor data from vehicular sensors or networks thereof and in particular relation to preferred device 1, vehicular operational sensing means 12 is adapted to receive such vehicular sensor data from a vehicles power train control module 13, or engine control module 14. Means 12 is adapted to receive vehicular data from modules 13 and or 14, through a vehicles OBD communications port 15. An example of such sensor data is engine rpm data and odometer data—which can also be used to verify data from one or more of the various sensing means (e.g. vehicle-power-supply-voltage-drop sensing means 6 data; vehicle-power-supply-voltage-noise sensing means 7 data; vehicle-control-system-communications-bus-high/low-voltage-change sensing means 8 data; and/or vehicle-acceleration sensing means 9 data).

The present invention also extends to a telematics system comprising an on-board, vehicular battery powered telematics device including a vehicle telemetry telecommunications means operable to communicate with a remote vehicular monitoring device, and including a vehicle-status-evaluating means operable to distinguishably sense between inactive-vehicle and active-vehicle states and including power-switching means operable to selectively power-up an associated vehicular device in response to a vehicle-status-evaluating means sensed active-vehicle state. The vehicular operational and/or positional sensing means is in turn, operable to sense corresponding operational and/or positional conditions verifying sensing-means sensed inactive or active states of a vehicle equipped with said device and the operational/positional data reporting telecommunication means is operable when so powered-up to report a verified vehicle state to said remote vehicular monitoring device. Such a system is preferably computer network enabled. In particular, a web-enabled telemetry system is preferred. Such a system is adapted to distribute vehicle-status-evaluating means and sensing means data according to the present invention, as well as verifications and derivations thereof, through a network, and in particular the internet for access by a web-browser. This substantially lowers the cost of implementing telemetry applications facilitated in accordance with the present invention. Such a systems may include a host device which acts as a network server that plugs into the local area network or LAN (e.g. with standard CAT5 and RJ-45 connectors) or into a wider area network, intranet or other distributed network. The host device may be connected to remote units over phone lines or wireless links to the Internet. Data are sent and received between the host and remote units in standard Transmission Control Protocol/Internet Protocol (TCP/IP) packets, or following some other protocol if desired. Client computers connected anywhere on the LAN or the Internet etc. can use a standard Web browser to display the collected data with no requirement for additional software. In some cases, integrated Java applets provide real-time telemetry display.

With accumulated data published as Web pages over an Ethernet LAN or over the Internet, it is possible to monitor vehicular activity through a browser from anywhere in the world where network or telecommunications access is available.
Through a web browser on such a system, an administrator can set monitoring and measurement parameters from any computer on the network and remotely configure and change all communication parameters of the monitored vehicles. Selectable local disk archiving protects data for future reference should the any on-board vehicular memory storage fail.

In yet another aspect of the present invention, there is provided a vehicular activity state telemetry display. The display is responsive to a remote vehicle-status-evaluating means operable to distinguishably sense between inactive-vehicle and active-vehicle states and including power-switching means operable to selectively power-up an associated vehicular device in response to a vehicle-status-evaluating means sensed active-vehicle state. More specifically the display is operable to display a monitored vehicles current activity state and receive data from the selectively powered-up associated vehicular device. A display of the sensor means data, and verifications thereof may be cross-referenced to a management directives protocol, providing case specific directions on how to manage specific circumstances of sensed data and the presence or absence of verifications.

In addition, the present invention relates to a method for selectively powering-up a vehicular device, employing vehicle-status-evaluating means to distinguishably sense between inactive-vehicle and active-vehicle states and operating power-switching means operable to selectively power-up an associated vehicular device in response to a vehicle-status-evaluating means sensed active-vehicle state.

1. Vehicle-status-evaluating means operable to distinguishably sense between inactive-vehicle and active-vehicle states and including power-switching means operable to selectively power-up an associated vehicular device in response to a vehicle-status-evaluating means sensed active-vehicle state.

2. The vehicle-status-evaluating means according to claim 1, wherein said power-switching means is operable to selectively power-up and power-down an associated vehicular device in response, respectively, to corresponding, vehicle-status-evaluating means sensed active-vehicle and inactive-vehicle states.

3. The vehicle-status-evaluating means according to claim 1, wherein said power-switching means further includes clock means operable to periodically power-up said associated vehicular device.

4. The vehicle-status-evaluating means according to claim 2, wherein said clock means is operable to:
Power-up said associated vehicular device at a predetermined time; and/or
Power-up said associated vehicular device at a predetermined interval of time following from said associated vehicular devices latest power-down.

5. The vehicle-status evaluating means according to claim 4, wherein said clock means is operable to power-down said associated vehicular device, a predetermined time interval following its clock power-up of said device, or on some condition signaled by the device to indicate completion of a clock-mandated task etc.

6. The vehicle-status-evaluating means according to claim 1, comprising one or more of the group consisting of:
Vehicle-power-supply-voltage-drop sensing means;
Vehicle-power-supply-voltage-noise sensing means;
Vehicle-control-system-communications-bus-high/low-voltage-change sensing means;
Vehicle-acceleration sensing means,
wherein said vehicle status evaluating means distinguishes between inactive-vehicle and active-vehicle states corresponding to one or more of:
a vehicle-power-supply-voltage-drop sensing means sensed vehicle power supply voltage drop;
a vehicle-power-supply-voltage-noise sensing means sensed vehicle power supply voltage noise;
a vehicle-control-system-communications-bus-high/low-voltage-change sensing means sensed high/low voltage change on said vehicle control module communication bus; and/or,
a vehicle-acceleration-sensing means sensed vehicle acceleration.

7. The vehicle-status-evaluating means according to claim 6, wherein said vehicle-acceleration sensing means comprises one or more of:
shock-sensing means; and, vehicle travel-sensing means.

8. The vehicle-status-evaluating means according to claim 6, further including signaling means to signal one or more of said:
sensed vehicle power supply voltage drop;
sensed vehicle power supply voltage noise;
sensed high/low voltage change on said vehicle control module communication bus; and/or,
sensed vehicle acceleration.

9. A GNSS receiver operable in connection with a vehicle-status-evaluating means itself operable to distinguishably sense between inactive-vehicle and active-vehicle states and including power-switching means operable to selectively power-up said GNSS receiver in response to a vehicle-status-evaluating means sensed active-vehicle state.

10. A vehicular battery-powered, on-board telematics device comprising:
a. vehicular operational sensing and/or positional sensing means operable to be powered-down during corresponding states of vehicle inactivity;
b. connected in data transferring relation to one or both of:
i. operational and/or positional data reporting telecommunications means; and,
ii. operational and/or positional data logging means;
and,
c. vehicle status evaluating means operable to distinguish between inactive vehicle and active vehicle states, and comprising one or more of the group consisting of:
i. vehicle power supply voltage drop sensing means;
ii. vehicle power supply voltage noise sensing means;
iii. vehicle control system communications bus high/low voltage change sensing means;
iv. vehicle acceleration sensing means comprising one or more of:
1. shock-sensing means; and,
2. vehicle relocation-sensing means,
wherein said vehicle status evaluating means distinguishes between inactive and active vehicle states corresponding to one or more of:
a vehicle power supply voltage drop sensing means sensed vehicle power supply voltage drop;
a vehicle power supply voltage noise sensing means sensed vehicle power supply voltage noise;
a vehicle control system communications bus high/low voltage change sensing means sensed high/low voltage change on said vehicle control module communication bus; and/or,
sensed vehicle acceleration; and,
wherein said vehicle status evaluating means is co-operable with said vehicular operational sensing and/or positional sensing means to selectively power-up said vehicular operational and/or positional sensing means in response to a vehicle status evaluating means sensed active state; and,
wherein said vehicular operational and/or positional sensing means is in turn, operable to sense corresponding operational and/or positional conditions verifying sensing-means sensed inactive or active states of a vehicle equipped with said device; and,
wherein said operational/positional data reporting telecommunication means and/or operational/positional data logging means are operable when so powered-up to respectively report/log a verified vehicle state.

11. The device according to claim 10, further comprising clock means operable to periodically power-up said powered-down vehicular operational sensing and/or positional sensing means during a corresponding states of vehicle inactivity.

12. The device according to claim 11, wherein said clock means is operable to periodically power-up vehicular operational sensing and/or positional sensing means during corresponding states of vehicle inactivity, a predetermined period of time following powering-down thereof.

13. The device according to claim 12, wherein said operational sensing and/or positional sensing means comprises a GPS receiver, and said predetermined period of time is selected to update said receiver's ephemeris data.

14. The device according to claim 10, wherein said operational sensing and/or positional sensing means comprises a GNSS receiver.

15. The device according to claim 10, wherein said operational and/or positional data reporting telecommunications means comprises wireless communications means.

16. The device according to claim 14 wherein said GNSS receiver is operable to sense corresponding operational and/or positional conditions verifying sensing-means sensed inactivity or activity states of a vehicle equipped with said device, by confirming changes in vehicular position data.

17. The device according to claim 10 wherein said vehicular operational and/or positional sensing means comprises vehicular operational sensing means.

18. The device according to claim 17 wherein vehicular operational sensing means comprises means for means for receiving or receiving/processing, whether directly or indirectly, vehicular sensor data from vehicular sensors or networks thereof.

19. The device according to claim 18, wherein said vehicular operational sensing means is adapted to receive said vehicular sensor data from a vehicles power train control module, or engine control module.

20. The device according to claim 19, wherein said vehicular operational sensing means is adapted to receive said vehicular data through a vehicles OBD communications port.

21. The device according to claim 18, wherein said sensor data includes engine rpm data.

22. A telematics system comprising an on-board, vehicular battery powered telematics device including a vehicle telemetry telecommunications means operable to communicate with a remote vehicular monitoring device, and including a vehicle-status-evaluating means operable to distinguishably sense between inactive-vehicle and active-vehicle states and including power-switching means operable to selectively power-up an associated vehicular device in response to a vehicle-status-evaluating means sensed active-vehicle state.

23. The telematics system according to claim 22, wherein said telematics device comprises:
a. vehicular operational sensing and/or positional sensing means operable to be powered-down during corresponding states of vehicle inactivity, and connected in data transferring relation to said operational and/or positional data reporting telecommunications means;
b. vehicle status evaluating means operable to distinguish between inactive vehicle and active vehicle states, and comprising one or more of the group consisting of:
i. vehicle power supply voltage drop sensing means;
ii. vehicle power supply voltage noise sensing means;
iii. vehicle control system communications bus high/low voltage change sensing means;
iv. vehicle acceleration sensing means comprising one or more of:
3. shock-sensing means; and,
4. vehicle relocation-sensing means,
wherein said vehicle status evaluating means distinguishes between inactive and active vehicle states corresponding to one or more of:
a vehicle power supply voltage drop sensing means sensed vehicle power supply voltage drop;
a vehicle power supply voltage noise sensing means sensed vehicle power supply voltage noise;
a vehicle control system communications bus high/low voltage change sensing means sensed high/low voltage change on said vehicle control module communication bus; and/or,
a sensed vehicle acceleration; and,
wherein said vehicle status evaluating means is co-operable with said vehicular operational sensing and/or positional sensing means to selectively power-up said vehicular operational and/or positional sensing means in response to a vehicle status evaluating means sensed active state; and,
wherein said vehicular operational and/or positional sensing means is in turn, operable to sense corresponding operational and/or positional conditions verifying sensing-means sensed inactive or active states of a vehicle equipped with said device; and,
wherein said operational/positional data reporting telecommunication means is operable when so powered-up to report a verified vehicle state to said remote vehicular monitoring device.

24. A vehicular activity state telemetry display:
responsive to a remote vehicle-status-evaluating means operable to distinguishably sense between inactive-vehicle and active-vehicle states and including power-switching means operable to selectively power-up an associated vehicular device in response to a vehicle-status-evaluating means sensed active-vehicle state; and,
operable in response thereto, to display said vehicles current activity state and receive data form said selectively powered-up associated vehicular device.

25. A method for selectively powering-up a vehicular device, employing vehicle-status-evaluating means to distinguishably sense between inactive-vehicle and active-vehicle states and operating power-switching means operable to selectively power-up an associated vehicular device in response to a vehicle-status-evaluating means sensed active-vehicle state.
